(19) United States
(12) Patent Application Publication
(10) Pub. No.: US 2024/0343050 A1
(43) Pub. Date: Oct. 17, 2024

(54) IMAGE FORMING APPARATUS CAPABLE OF PREVENTING FLOATING OF WIDTHWISE END PORTIONS OF ENDLESS BELT

(71) Applicant: KYOCERA Document Solutions Inc., Osaka (JP)

(72) Inventor: Satoru NAKAMURA, Osaka (JP)

(73) Assignee: KYOCERA Document Solutions Inc., Osaka (JP)

(21) Appl. No.: 18/630,060

(22) Filed: Apr. 9, 2024

(30) Foreign Application Priority Data
Apr. 12, 2023 (JP) 2023-064704

(51) Int. Cl. B41J 13/08; B41J 2/165; B41J 11/00; B65H 5/22

(52) U.S. Cl. CPC B41J 13/08; B41J 2/16526; B41J 11/0085; B65H 5/224; B65H 2404/25

(57) ABSTRACT

An image forming apparatus includes a recording head, an endless belt, a plurality of through holes for flashing, a droplet receiver, and an anti-floating member. In the recording head, a plurality of nozzles capable of ejecting droplets onto a recording medium are arranged. The endless belt conveys the recording medium toward a position where an image is to be formed on the recording medium by the recording head. The through holes are formed in the endless belt. The droplet receiver receives flashing droplets having been ejected from the nozzles by flashing without contributing to formation of the image and having passed through the through holes. The anti-floating member prevents floating of end portions of the endless belt in a widthwise direction of the endless belt.

### INCORPORATION BY REFERENCE

This application claims priority to Japanese Patent Application No. 2023-064704 filed on 12 Apr. 2023, the entire contents of which are incorporated by reference herein.

### BACKGROUND

The present disclosure relates to image forming apparatuses that form an image.

There is generally known an image recording apparatus equipped with a conveying belt that conveys a sheet. The conveying belt is provided with: a large number of through holes through which air is sucked to attract a sheet to the surface of the conveying belt; and a plurality of through holes for flashing through which, during flashing, ink droplets ejected from nozzles pass.

### SUMMARY

A technique improved over the aforementioned technique is proposed as one aspect of the present disclosure.

An image forming apparatus according to an aspect of the present disclosure includes a recording head, an endless belt, a plurality of through holes for flashing, a droplet receiver, and an anti-floating member. In the recording head, a plurality of nozzles capable of ejecting droplets onto a recording medium are arranged. The endless belt conveys the recording medium toward a position where an image is to be formed on the recording medium by the recording head. The through holes are formed in the endless belt. The droplet receiver receives flashing droplets having been ejected from the nozzles by flashing without contributing to formation of the image and having passed through the through holes. The anti-floating member prevents floating of end portions of the endless belt in a widthwise direction of the endless belt.

### BRIEF DESCRIPTION OF THE DRAWINGS

FIG. 1 is a schematic view showing the structure of an image forming apparatus according to a first embodiment.

FIG. 2 is a perspective view of a conveyance device of the image forming apparatus according to the first embodiment and shows a state where the conveyance device is fitted with a conveying belt.

FIG. 3 is a plan view of the conveying belt of the image forming apparatus according to the first embodiment.

FIG. 4 is a perspective view of the conveyance device of the image forming apparatus according to the first embodiment and shows a state where the conveying belt is removed from the conveyance device to expose a support plate.

FIG. 5 is a perspective view of a head unit of the image forming apparatus according to the first embodiment.

FIG. 6 is a schematic enlarged view of a portion of the image forming apparatus according to the first embodiment.

FIG. 7 is a view taken along the arrowed line A-A in FIG. 6.

FIG. 8 is an enlarged view of an anti-floating member of an image forming apparatus according to a second embodiment.

FIG. 9 is an enlarged view of an anti-floating member of an image forming apparatus according to a third embodiment.

FIG. 10 is an enlarged view of an anti-floating member of an image forming apparatus according to a fourth embodiment.

### DETAILED DESCRIPTION

Hereinafter, a description will be given of embodiments of the present disclosure with reference to the drawings. Throughout the drawings, the same or equivalent parts and components are designated by the same reference characters and further description is omitted.

### First Embodiment

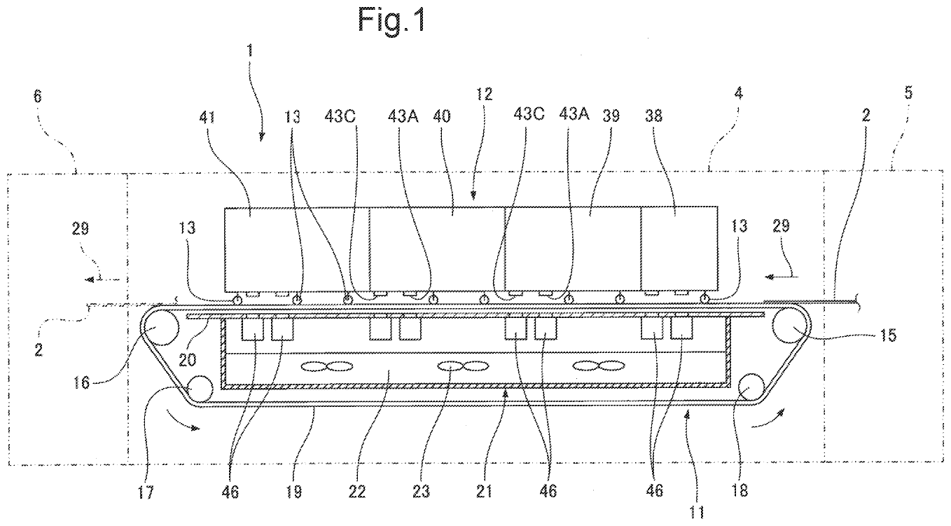

With reference to FIG. 1, an image forming apparatus 1 according to a first embodiment will be described. FIG. 1 is a schematic view showing the structure of the image forming apparatus 1 according to the first embodiment. The image forming apparatus 1 is an apparatus that forms an image and is, for example, a color multifunction peripheral that has the function of executing a plurality of jobs, including copying, printing, scanning, and facsimile communication. The image forming apparatus 1 includes: a printing device 4 that records an image or so on on a sheet 2 (an example of a recording medium defined in CLAIMS), for example, by an ink-jet system; a sheet feed device 5 that feeds the sheet 2 to the printing device 4; and a drying device 6 that dries the sheet 2 with the image or so on recorded thereon.

The sheet 2 fed from the sheet feed device 5 to the printing device 4 is subjected to recording of an image or so on in the printing device 4, then transferred from the printing device 4 to the drying device 6, dried in the drying device 6, and ejected.

The printing device 4 of the image forming apparatus 1 includes: a conveyance device 11 that conveys the sheet 2; a recording device 12 that ejects ink onto the sheet 2 being conveyed; and a plurality of anti-floating members 13.

The conveyance device 11 includes: a plurality of rollers 15, 16, 17, and 18; an endless conveying belt 19 (an example of an endless belt defined in CLAIMS) mounted around the rollers 15, 16, 17, and 18; a support plate 20 (referred to also as a platen) that supports the conveying belt 19 from below; and a suction device 21 that sucks the sheet 2 fed from the sheet feed device 5 onto the conveying belt 18 to attract it to the surface of the conveying belt 19.

When any one of the rollers 15, 16, 17, and 18 is forcedly driven into rotation by a motor or so on, the conveying belt 19 is rotated in one direction and the remaining rollers follow the rotation of the conveying belt 19 to rotate. The conveying belt 19 conveys the sheet 2 toward a position where an image is to be formed on the sheet 2 by recording heads 43A, 43B, and 43C to be described hereinafter.

The suction device 21 includes: a suction room 22 formed under the support plate 20; and a plurality of suction fans 23 provided in the suction room 22. The support plate 20 forms a ceiling of the suction room 22. The recording device 12 includes a plurality of head units 38, 39, 40, and 41.

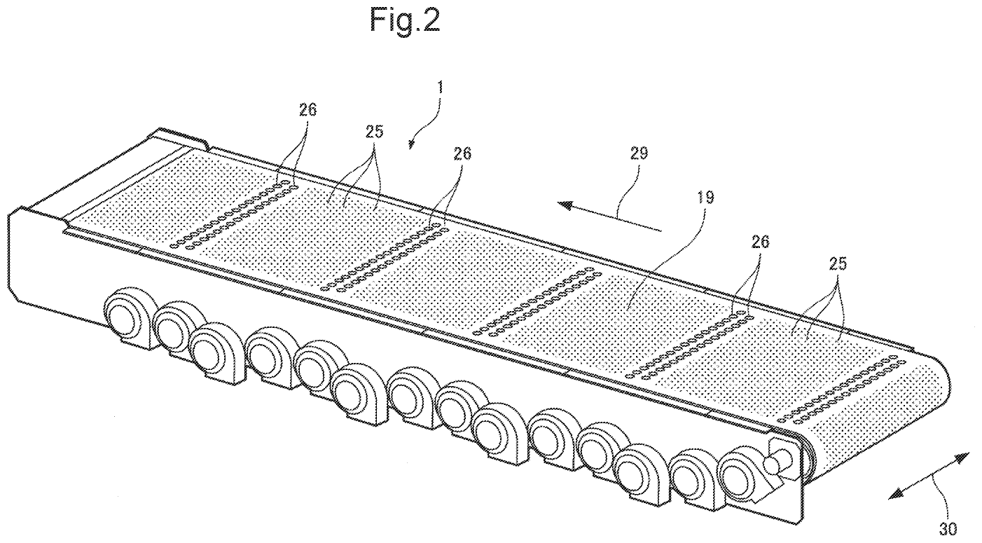

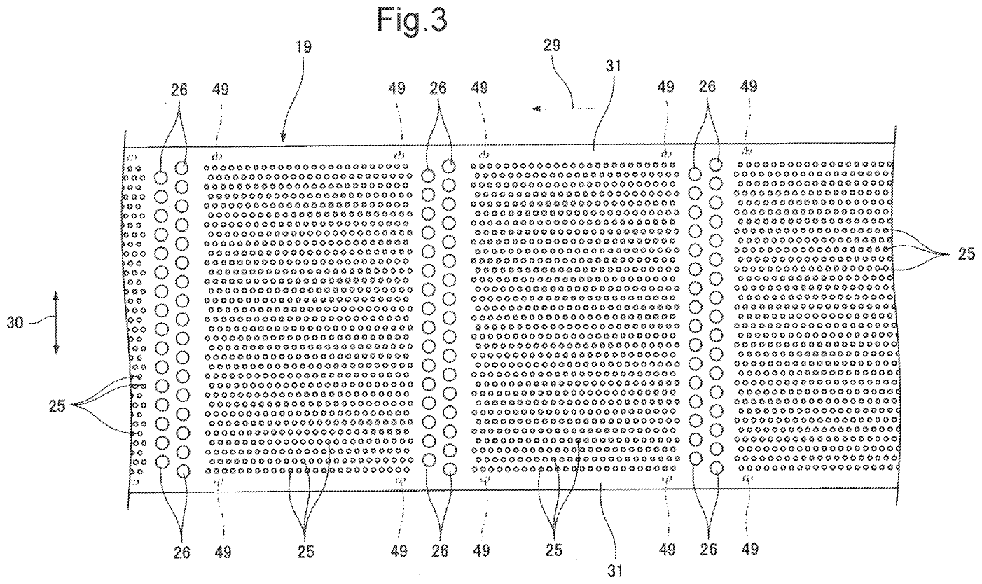

Next, the conveying belt 19 will be described in detail with reference to FIGS. 2 and 3. FIG. 2 is a perspective view of the conveyance device 11 of the image forming apparatus 1 according to the first embodiment and shows a state where the conveyance device 11 is fitted with the conveying belt 19. FIG. 3 is a plan view of the conveying belt 19 of the image forming apparatus 1.

In the conveying belt 19, a large number of suction holes 25 and a plurality of through holes 26 for flashing are formed to penetrate both sides of the conveying belt 19. The diameter of the through holes 26 is set larger than the diameter of the suction holes 25.

The direction orthogonal to a direction of movement 29 of the conveying belt 19 is defined as a widthwise direction 30 of the conveying belt 19. In both end portions of the conveying belt 19 in the widthwise direction 30 thereof, holeless areas 31 free of suction holes 25 and through holes 26 are formed over the entire circumference of the conveying belt 19.

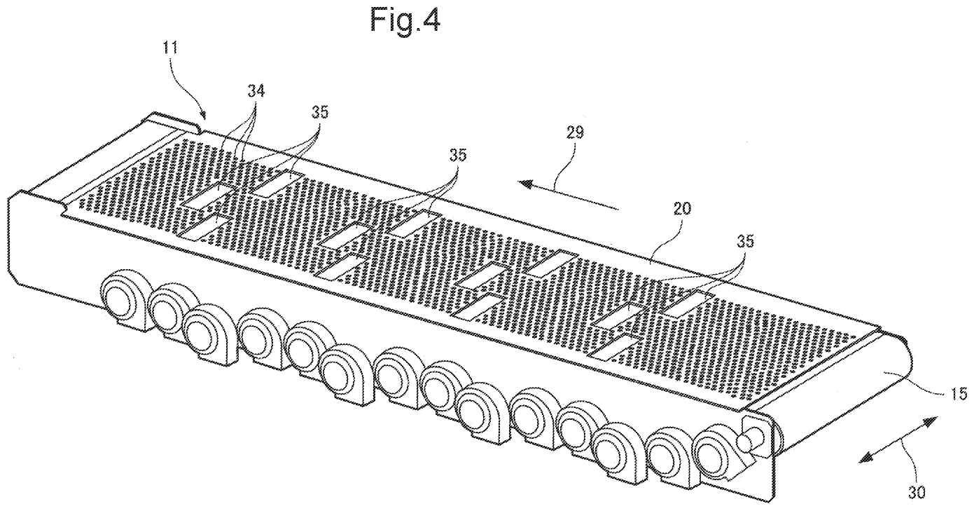

Next, the support plate 20 will be described in detail with reference to FIG. 4. FIG. 4 is a perspective view of the conveyance device 11 of the image forming apparatus 1 according to the first embodiment and shows a state where the conveying belt 19 is removed from the conveyance device 11 to expose the support plate 20.

In the support plate 20, a large number of air inlets 34 and a plurality of communication holes 35 for flashing are formed to penetrate through the support plate 20 vertically. The opening area of each of the communication holes 35 is set wider than the opening area of each of the air inlets 34.

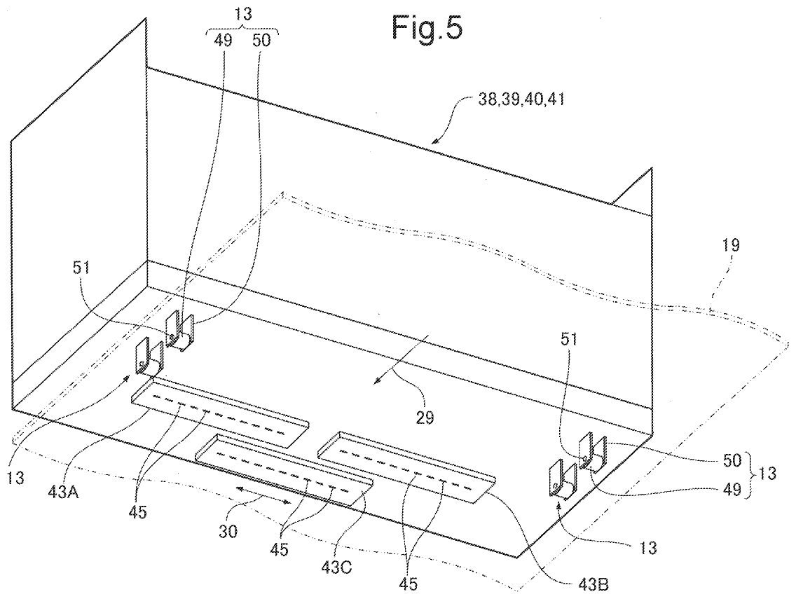

Next, the head units 38, 39, 40, and 41 will be described in detail with reference to FIG. 5. FIG. 5 is a perspective view of a head unit 38, 39, 40, 41 of the image forming apparatus 1 according to the first embodiment.

Each of the head units 38, 39, 40, and 41 provided in the recording device 12 includes a set of recording heads 43A, 43B, and 43C. The set of recording heads 43A, 43B, and 43C are staggered along the widthwise direction 30 of the conveying belt 19.

In each of the recording heads 43A, 43B, and 43C, a plurality of nozzles 45 (ejection holes) from which ink droplets are to be ejected onto a sheet 2 are arranged. A yellow ink is ejected from the nozzles 45 in the first head unit 38. A magenta ink is ejected from the nozzles 45 in the second head unit 39. A cyan ink is ejected from the nozzles 45 in the third head unit 40. A black ink is ejected from the nozzles 45 in the fourth head unit 41. The communication holes 35 in the support plate 20 are located, one just under each of the recording heads 43A, 43B, and 43C.

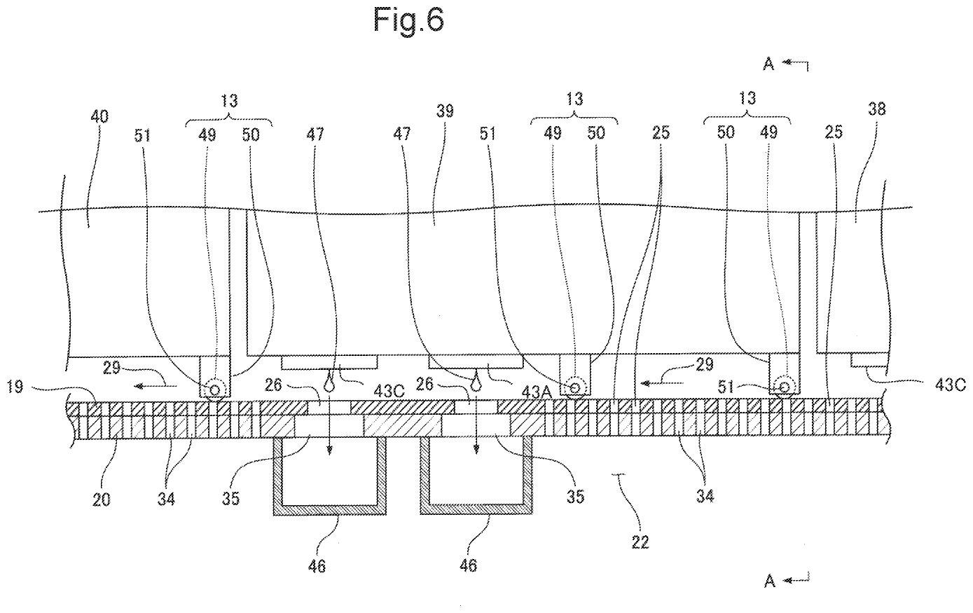

Next, flashing of the image forming apparatus 1 will be described with reference to FIG. 6. FIG. 6 is a schematic enlarged view of a portion of the image forming apparatus 1 according to the first embodiment. The suction room 22 is provided internally with a plurality of droplet receivers 46 that receive ink droplets 47 (an example of flashing droplets defined in CLAIMS) having been ejected from the nozzles 45 by flashing without contributing to the formation of the image and having passed through the through holes 26 in the conveying belt 19 and the communication holes 35 in the support plate 20.

The sheet 2 fed from the sheet feed device 5 onto the conveying belt 19 of the printing device 4 is conveyed in the direction of movement 29 by the rotating conveying belt 19. In doing so, the suction fans 23 rotate to reduce the pressure in the suction room 22 and, thus, the outside air flows into the suction room 22 through the suction holes 25 and the through holes 26 in the conveying belt 19 and the air inlets 34 and the communication holes 35 in the support plate 20. This air flow causes the sheet 2 to be attracted to the surface of the conveying belt 19.

Thus, the sheet 2 is conveyed in the direction of movement 29 without leaving the conveying belt 19. During this conveyance, ink droplets are ejected from the nozzles 45 of the recording heads 43A, 43B, and 43C onto the sheet 2 being conveyed, thus forming an image on the sheet 2.

The anti-floating members 13 prevent floating of both the end portions of the conveying belt 19 in the widthwise direction 30 thereof. As a result, both the end portions of the conveying belt 19 in the widthwise direction 30 thereof can be prevented from floating and, thus, a problem of contact of the end portions of the conveying belt 19 with the recording heads 43A, 43B, and 43C can be avoided.

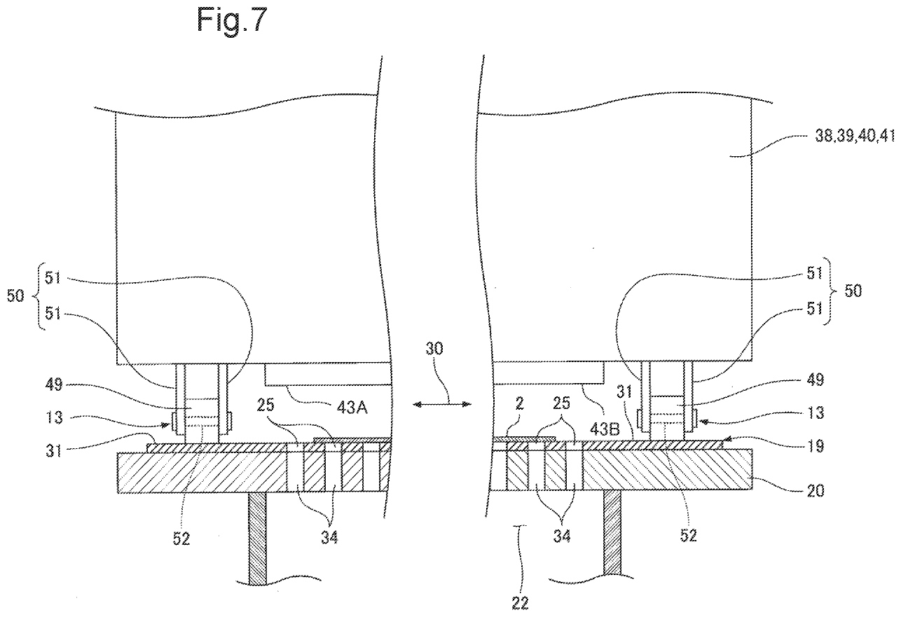

Next, the anti-floating members 13 will be described in detail with reference to FIGS. 6 and 7. FIG. 7 is a view taken along the arrowed line A-A in FIG. 6. A plurality of anti-floating members 13 are provided at the bottom of each of the head units 38, 39, 40, and 41.

Each of the anti-floating members 13 includes: a circular roller 49 (an example of a rotator defined in CLAIMS) that holds down an associated one of the holeless areas 31 located at both the widthwise end portions of the conveying belt 19; and a retaining member 50 that retains the roller 49 freely rotatably. The retaining member 50 includes a pair of retaining plates 51 mounted to the bottom of an associated one of the head units 38, 39, 40, and 41.

The roller 49 is freely rotatable along the direction of movement 29 of the conveying belt 19. Specifically, the roller 49 is freely rotatably mounted between the pair of retaining plates 51 through a rotary shaft 52 extending along the widthwise direction 30 of the conveying belt 19. As a result, during movement of the conveying belt 19 in the direction of movement 29, the roller 49 rotates around the rotary shaft 52 while keeping in contact with the conveying belt 19. Thus, both the end portions of the conveying belt 19 in the widthwise direction 30 thereof can be certainly held down.

The anti-floating members 13 are, for each of the sets of recording heads 43A, 43B, and 43C, allocated upstream and downstream of (behind and ahead of) the set of recording heads 43A, 43B, and 43C in the direction of movement 29 of the conveying belt 19. As a result, the problem of floating of the widthwise end portions of the conveying belt 19 and the resulting contact with the recording heads 43A, 43B, and 43C can be more certainly avoided.

In performing flashing, with no sheet 2 fed onto the conveying belt 19, ink droplets 47 are ejected from the nozzles 45 of the recording heads 43A, 43B, and 43C to coincide with the time when the through holes 26 in the conveying belt 19 moving in the direction of movement 29 pass just under the nozzles 45. Thus, the ink droplets 47 pass through the through holes 26 in the conveying belt 19 and the communication holes 35 in the support plate 20 and are received by the droplet receivers 46.

By periodically performing the above flashing, clogging of the nozzles 45 due to drying of ink can be prevented.

### Second Embodiment

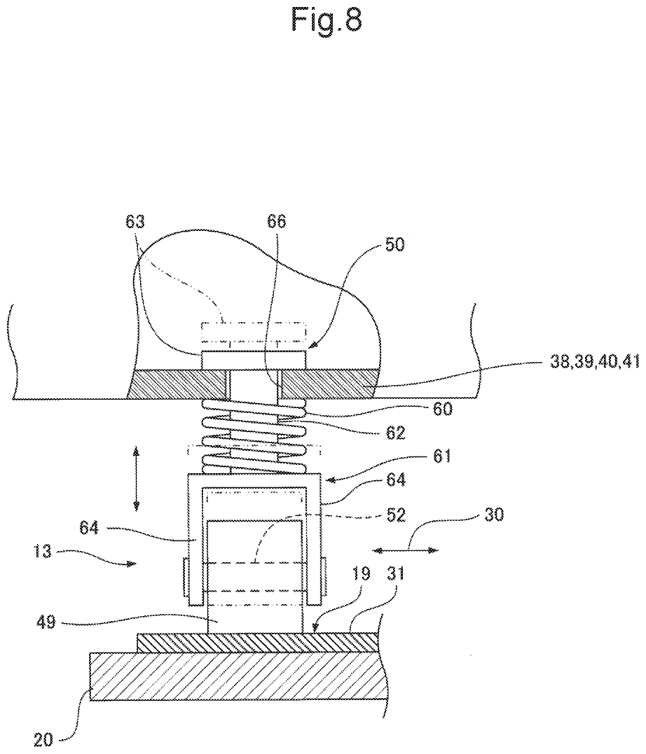

With reference to FIG. 8, an anti-floating member 13 according to a second embodiment will be described. FIG. 8 is an enlarged view of an anti-floating member 13 of an image forming apparatus 1 according to a second embodiment. The second embodiment is different from the first embodiment mainly in that the anti-floating member 13 according to the second embodiment includes a spring 60 as an example of a biasing member defined in CLAIMS. Hereinafter, a description will be given mainly of differences of the second embodiment from the first embodiment.

The anti-floating member 13 includes: a roller 49 (an example of a rotator defined in CLAIMS); a retaining member 50 that retains the roller 49 freely rotatably; and a coiled spring 60 (an example of a biasing member defined in CLAIMS) that biases the roller 49 downward.

The retaining member 50 includes a C-shaped retaining frame 61, a retaining shaft 62 standing upright from the retaining frame 61, and a flange 63 provided on the top of the retaining shaft 62 to prevent from falling off. The retaining frame 61 includes a pair of retaining plates 64. The roller 49 is freely rotatably mounted through a rotary shaft 52 between the pair of retaining plates 64.

The retaining shaft 62 is inserted into a rectangular retaining hole 66 formed in the bottom of an associated one of the head units 38, 39, 40, and 41. The horizontal cross-section of the retaining shaft 62 is formed into a rectangular shape like the retaining hole 66. Thus, the retaining member 50 is held movable in a vertical direction, but stationary without rotation about the axis of the retaining shaft 62.

The flange 63 extends horizontally from the top of the retaining shaft 62. The flange 63 engages with the bottom of the associated head unit 38, 39, 40, 41 from above to prevent the anti-floating member 13 from falling off the heat unit 38, 39, 40, 41.

The spring 60 is mounted in a compressed state between the retaining frame 61 and the bottom of the associated head unit 38, 39, 40, 41. The retaining shaft 62 vertically extends through the spring 60.

In accordance with the above structure, the roller 49 is pressed down by the biasing force of the spring 60 and, therefore, the roller 49 is certainly pressed against the conveying belt 19. Furthermore, the retaining member 50 moves vertically to change the amount of compression of the spring 60, which increases or decreases the vertical distance between the roller 49 and the support plate 20. Therefore, even if the thickness of the conveying belt 19 changes, the roller 49 is held pressed against the conveying belt 19 and moves vertically while following the change in the thickness of the conveying belt 19.

### Third Embodiment

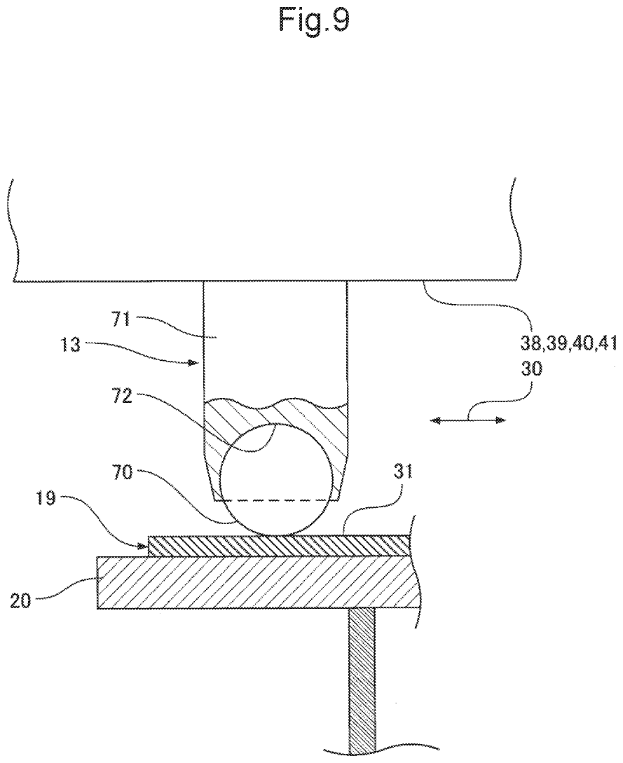

With reference to FIG. 9, an anti-floating member 13 according to a third embodiment will be described. FIG. 9 is an enlarged view of an anti-floating member 13 of an image forming apparatus 1 according to a third embodiment. The third embodiment is different from the first embodiment mainly in that the rotator provided in the anti-floating member 13 according to the third embodiment is a sphere 70. Hereinafter, a description will be given mainly of differences of the third embodiment from the first embodiment.

The anti-floating member 13 includes: a sphere 70 (an example of the rotator defined in CLAIMS) that holds down an associated one of the holeless areas 31 located at both the widthwise end portions of the conveying belt 19; and a retaining member 71 that retains the sphere 70 freely rotatably. The retaining member 71 has a semispherical recess 72 opening downward. The sphere 70 is fitted freely rotatably into the recess 72.

In accordance with the above structure, during movement of the conveying belt 19 in the direction of movement 29, the sphere 70 rotates while keeping in contact with the conveying belt 19. Thus, both the end portions of the conveying belt 19 in the widthwise direction 30 thereof can be certainly held down by the spheres 70 and therefore prevented from floating and, thus, a problem of contact of the end portions of the conveying belt 19 with the recording heads 43A, 43B, and 43C can be avoided.

### Fourth Embodiment

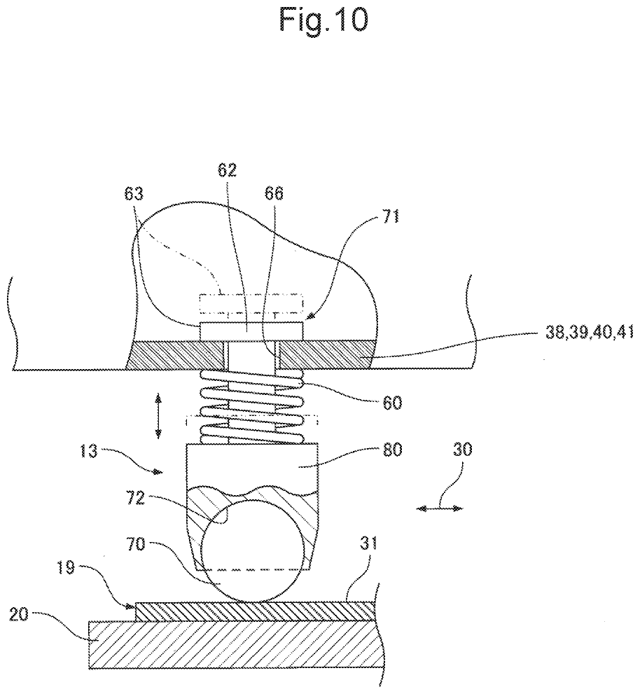

With reference to FIG. 10, an anti-floating member 13 according to a fourth embodiment will be described. FIG. 10 is an enlarged view of an anti-floating member 13 of an image forming apparatus 1 according to a fourth embodiment. The fourth embodiment is different from the third embodiment mainly in that the anti-floating member 13 according to the fourth embodiment includes a spring 60 as an example of the biasing member defined in CLAIMS. Hereinafter, a description will be given mainly of differences of the fourth embodiment from the third embodiment.

The anti-floating member 13 includes: a sphere 70 (an example of the rotator defined in CLAIMS); a retaining member 71 that retains the sphere 70 freely rotatably; and a coiled spring 60 (an example of the biasing member defined in CLAIMS) that biases the sphere 70 downward.

The retaining member 71 includes: a retaining block 80 having a recess 72 formed therein; a retaining shaft 62 standing upright from the retaining block 80; and a flange 63 provided on the top of the retaining shaft 62 to prevent from falling off. The spring 60 is mounted in a compressed state between the retaining block 80 and the bottom of the associated head unit 38, 39, 40, 41.

In accordance with the above structure, the sphere 70 is pressed down by the biasing force of the spring 60 and, therefore, the sphere 70 is certainly pressed against the conveying belt 19. Furthermore, the retaining member 71 moves vertically to change the amount of compression of the spring 60, which increases or decreases the vertical distance between the sphere 70 and the support plate 20. Therefore, even if the thickness of the conveying belt 19 changes, the sphere 70 is held pressed against the conveying belt 19 and moves vertically while following the change in the thickness of the conveying belt 19.

In the general image forming apparatus described previously, a large number of through holes are formed in a central portion of the conveying belt in the widthwise direction thereof, but both the end portions of the conveying belt in the widthwise direction thereof are free of through holes. Therefore, when tension is applied to the conveying belt, a difference in amount of stretch occurs between the central portion and both the end portions of the conveying belt in the widthwise direction thereof, which may deform the conveying belt and float both the end portions of the conveying belt. If both the end portions of the conveying belt float, they may make contact with the recording heads.

Unlike the above, in the first to fourth embodiments, the image forming apparatus 1 includes anti-floating members 13. Therefore, an image forming apparatus capable of preventing floating of both the end portions of the conveying belt 19 in the widthwise direction thereof can be provided.

The description of the embodiments of the present disclosure has so far been given with reference to the drawings. However, the present disclosure is not limited to the above embodiments and can be implemented in various forms without departing from the gist of the present disclosure. For the sake of ease of understanding, the drawings may be schematic representation, primarily of components. The thickness of each component shown in the drawings, the length thereof, the number of components, the distance between the components, and so on may be different from those of actual components for convenience of creation of the drawings. The material, shape, size, and so on of each component described in the above embodiments are merely illustrative, not particularly limited, and can be changed variously without substantially departing from the effects of the present disclosure.

### INDUSTRIAL APPLICABILITY

The present disclosure provides an image forming apparatus and has an industrial applicability.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
a recording head in which a plurality of nozzles capable of ejecting droplets onto a recording medium are arranged;
an endless belt that conveys the recording medium toward a position where an image is to be formed on the recording medium by the recording head;
a plurality of through holes for flashing formed in the endless belt;
a droplet receiver that receives flashing droplets having been ejected from the nozzles by flashing without contributing to formation of the image and having passed through the through holes; and
an anti-floating member that prevents floating of end portions of the endless belt in a widthwise direction of the endless belt.

2. The image forming apparatus according to claim 1, wherein
the anti-floating member comprises a rotator that holds down the end portions of the endless belt, and
the rotator is freely rotatable along a direction of movement of the endless belt.

3. The image forming apparatus according to claim 1, wherein the recording head and the anti-floating member are provided in a head unit.

4. The image forming apparatus according to claim 1, wherein the anti-floating member comprises a plurality of anti-floating members and the plurality of anti-floating members are allocated upstream and downstream of the recording head in a direction of movement of the endless belt.

5. The image forming apparatus according to claim 1, wherein the anti-floating member further comprises a biasing member that biases the rotator downward.
